(19) United States
(12) Patent Application Publication
(10) Pub. No.: US 2026/0046572 A1
(43) Pub. Date: Feb. 12, 2026

(54) TRANSDUCER FAILSAFE FOR MEDICAL IMPLANT

(71) Applicant: Cochlear Limited, Macquarie University, NSW (AU)

(72) Inventors: Antonin Rambault, Mechelen (BE); Koen Erik Van den Heuvel, Mechelen (BE); Floriaan Van Reusel, Mechelen (BE)

(21) Appl. No.: 19/101,455

(22) PCT Filed: Aug. 21, 2023
(86) PCT No.: PCT/IB2023/058331

§ 371 Date: Feb. 5, 2025

Related U.S. Application Data
(60) Provisional application No. 63/374,637, filed on Sep. 6, 2022.

(51) Int. Cl. H04R 25/00

(52) U.S. Cl. CPC H04R 25/606; H04R 2225/67

(57) ABSTRACT

An apparatus includes a transducer configured to be at least partially implanted on or within a recipient. The apparatus further includes a conduit having a longitudinal axis and configured to be at least partially implanted on or within the recipient. The conduit includes a first portion, a second portion, and at least one third portion. The first portion is configured to be in mechanical communication with the transducer. The second portion is configured to be in mechanical communication with a target portion of the recipient's body. The conduit is configured to transmit vibrations along the longitudinal axis between the transducer and the second portion of the recipient's body. The at least one third portion is configured to break and/or undergo plastic deformation upon a relative displacement between the transducer and the target portion of the recipient's body exceeding a predetermined threshold value.

### BACKGROUND

### Field

The present application relates generally to medical implants (e.g., implantable medical prostheses) having active components (e.g., transducers; actuators; microphones).

### Description of the Related Art

Medical devices have provided a wide range of therapeutic benefits to recipients over recent decades. Medical devices can include internal or implantable components/devices, external or wearable components/devices, or combinations thereof (e.g., a device having an external component communicating with an implantable component). Medical devices, such as traditional hearing aids, partially or fully-implantable hearing prostheses (e.g., bone conduction devices, mechanical stimulators, cochlear implants, etc.), pacemakers, defibrillators, functional electrical stimulation devices, and other medical devices, have been successful in performing lifesaving and/or lifestyle enhancement functions and/or recipient monitoring for a number of years.

The types of medical devices and the ranges of functions performed thereby have increased over the years. For example, many medical devices, sometimes referred to as “implantable medical devices,” now often include one or more instruments, apparatus, sensors, processors, controllers or other functional mechanical or electrical components that are permanently or temporarily implanted in a recipient. These functional devices are typically used to diagnose, prevent, monitor, treat, or manage a disease/injury or symptom thereof, or to investigate, replace or modify the anatomy or a physiological process. Many of these functional devices utilize power and/or data received from external devices that are part of, or operate in conjunction with, implantable components.

### SUMMARY

In one aspect disclosed herein, an apparatus comprises a transducer configured to be at least partially implanted on or within a recipient. The apparatus further comprises a conduit having a longitudinal axis and configured to be at least partially implanted on or within the recipient. The conduit comprises a first portion, a second portion, and at least one third portion. The first portion is configured to be in mechanical communication with the transducer. The second portion is configured to be in mechanical communication with a target portion of the recipient's body. The conduit is configured to transmit vibrations along the longitudinal axis between the transducer and the second portion of the recipient's body. The at least one third portion is configured to break and/or undergo plastic deformation upon a relative displacement between the transducer and the target portion of the recipient's body exceeding a predetermined threshold value.

In another aspect disclosed herein, a method comprises accessing an assembly implanted on or within a recipient's body. The assembly is affixed to a tissue portion having a tissue threshold force and/or impulse such that an applied force and/or impulse greater than the tissue threshold force and/or impulse applied to the tissue portion damages the tissue portion. The assembly comprises a mechanical failsafe having an assembly threshold force and/or impulse such that an applied force and/or impulse greater than the assembly threshold force and/or impulse applied to the assembly breaks the mechanical failsafe. The assembly threshold force and/or impulse is less than the tissue threshold force and/or impulse. The method further comprises explanting the assembly from the recipient's body, said explanting comprising applying a force and/or impulse to the assembly that is greater than the tissue threshold force and/or impulse.

In another aspect disclosed herein, a method comprises accessing an implanted device affixed to a tissue portion of a recipient. The device comprises a linkage configured to: respond to forces, impulses, and/or torques having a first range of magnitudes applied to the linkage by undergoing elastic deformation, respond to forces, impulses, and/or torques having a second range of magnitudes applied to the linkage by undergoing plastic deformation, and respond to forces, impulses, and/or torques having a third range of magnitudes applied to the linkage by separating into two sub-portions. The second range of magnitudes is greater than the first range of magnitudes, and the third range of magnitudes is greater than the second range of magnitudes. The method further comprises applying a force, impulse, and/or torque to a portion of the device on an opposite side of the linkage from the tissue portion.

### BRIEF DESCRIPTION OF THE DRAWINGS

Implementations are described herein in conjunction with the accompanying drawings, in which:

FIG. 1 is a perspective view of an example cochlear implant auditory prosthesis implanted in a recipient in accordance with certain implementations described herein;

FIG. 2 is a perspective view of an example fully implantable middle ear implant auditory prosthesis implanted in a recipient in accordance with certain implementations described herein;

FIG. 3 schematically illustrates a perspective view of an example actuator of another example implantable auditory prosthesis in accordance with certain implementations described herein;

FIGS. 4A-4C schematically illustrates an example apparatus in accordance with certain implementations described herein;

FIGS. 5A-5C schematically illustrate cross-sectional views of an elongate member comprising the at least one third portion in accordance with certain implementations described herein;

FIGS. 6A-6D schematically illustrate cross-sectional views of an example first portion comprising a first coupler and a second portion comprising a second coupler in accordance with certain implementations described herein;

FIGS. 7A and 7B schematically illustrate two cross-sectional views of a first portion and a second portion, respectively, of an example conduit in accordance with certain implementations described herein;

FIG. 8 schematically illustrates an example method in accordance with certain implementations described herein; and

FIG. 9 schematically illustrates another example method in accordance with certain implementations described herein.

### DETAILED DESCRIPTION

Certain implementations described herein provide an implantable medical device configured to be affixed to a sensitive and/or fragile tissue portion of the recipient's body (e.g., ossicular chain). The device comprises a linkage configured to mechanically fail (e.g., break; plastically deform) in response to sufficiently large forces, impulses, and/or torques that would otherwise cause pain to the recipient and/or damage if applied to the tissue portion. The linkage can serve as a weak point (e.g., weaker than the tissue portion) to protect the tissue portion integrity from excessive forces, impulses, and/or torques by failing before damage to the tissue portion can occur.

The teachings detailed herein are applicable, in at least some implementations, to any type of implantable medical system utilizing an implantable transducer assembly configured to provide stimulation signals to a portion of the recipient's body in response to received information and/or control signals (e.g., implantable sensor prostheses; implantable stimulation system). For example, the implantable medical system can comprise an auditory prosthesis system configured to generate and apply stimulation signals that are perceived by the recipient as sounds (e.g., evoking a hearing percept). Such implantable transducer assemblies can include but are not limited to: electro-acoustic electrical/acoustic systems, cochlear implant devices, implantable hearing aid devices, middle ear implant devices, bone conduction devices (e.g., active bone conduction devices; passive bone conduction devices, percutaneous bone conduction devices; transcutaneous bone conduction devices), Direct Acoustic Cochlear Implant (DACI), middle ear transducer (MET), electro-acoustic implant devices, other types of auditory prosthesis devices (e.g., auditory brain stimulators), and/or combinations or variations thereof, or any other suitable hearing prosthesis system with or without one or more external components. Merely for ease of description, apparatus and methods disclosed herein are primarily described with reference to an illustrative auditory prosthesis system, namely a middle ear implant, but implementations can include any type of auditory prosthesis that can utilize the teachings detailed herein and/or variations thereof. Certain such implementations can be referred to as “partially implantable,” “semi-implantable,” “mostly implantable,” “fully implantable,” or “totally implantable” auditory prostheses.

The teachings detailed herein and/or variations thereof may also be used with a variety of other medical devices that provide a wide range of therapeutic benefits to recipients, patients, or other users. For example, other sensory prosthesis systems that are configured to evoke other types of neural or sensory (e.g., sight, tactile, smell, taste) percepts are compatible with certain implementations described herein, including but are not limited to: vestibular devices (e.g., vestibular implants), visual devices (e.g., bionic eyes), visual prostheses (e.g., retinal implants), somatosensory implants, and chemosensory implants. In some implementations, the teachings detailed herein and/or variations thereof can be utilized in other types of implantable medical devices beyond sensory prostheses. For example, apparatus and methods disclosed herein and/or variations thereof can be used with one or more of the following: sensors; cardiac pacemakers; drug delivery systems; defibrillators; functional electrical stimulation devices; catheters; brain implants; seizure devices (e.g., devices for monitoring and/or treating epileptic events); sleep apnea devices; electroporation; pain relief devices; etc. Implementations can include any type of medical system that can utilize the teachings detailed herein and/or variations thereof.

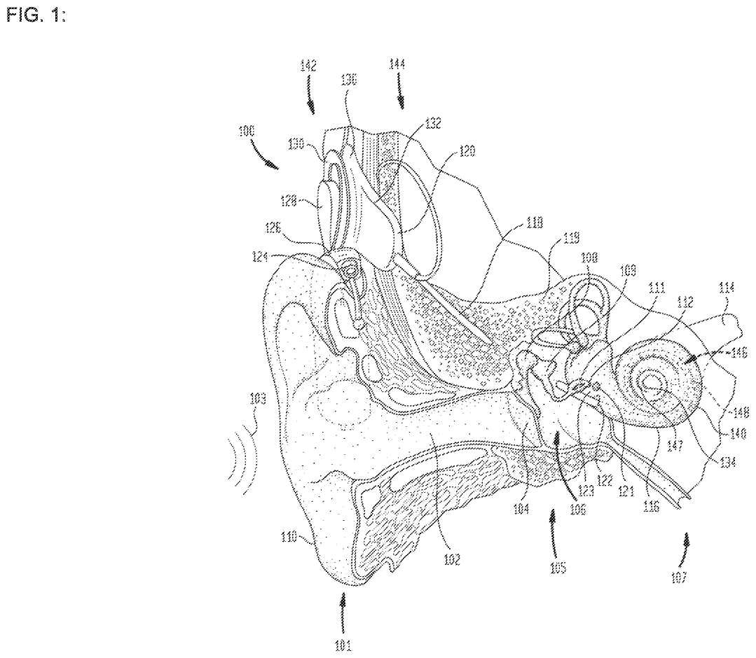

FIG. 1 is a perspective view of an example cochlear implant auditory prosthesis 100 implanted in a recipient in accordance with certain implementations described herein. The example auditory prosthesis 100 is shown in FIG. 1 as comprising an implanted stimulator unit 120 and a microphone assembly 124 that is external to the recipient (e.g., a partially implantable cochlear implant). An example auditory prosthesis 100 (e.g., a totally implantable cochlear implant; a mostly implantable cochlear implant) in accordance with certain implementations described herein can replace the external microphone assembly 124 shown in FIG. 1 with a subcutaneously implantable microphone assembly, as described more fully herein.

As shown in FIG. 1, the recipient has an outer ear 101, a middle ear 105, and an inner ear 107. In a fully functional ear, the outer ear 101 comprises an auricle 110 and an ear canal 102. An acoustic pressure or sound wave 103 is collected by the auricle 110 and is channeled into and through the ear canal 102. Disposed across the distal end of the ear canal 102 is a tympanic membrane 104 which vibrates in response to the sound wave 103. This vibration is coupled to oval window or fenestra ovalis 112 through three bones of middle ear 105, collectively referred to as the ossicles 106 and comprising the malleus 108, the incus 109, and the stapes 111. The bones 108, 109, and 111 of the middle ear 105 serve to filter and amplify the sound wave 103, causing the oval window 112 to articulate, or vibrate in response to vibration of the tympanic membrane 104. This vibration sets up waves of fluid motion of the perilymph within cochlea 140. Such fluid motion, in turn, activates tiny hair cells (not shown) inside the cochlea 140. Activation of the hair cells causes appropriate nerve impulses to be generated and transferred through the spiral ganglion cells (not shown) and auditory nerve 114 to the brain (also not shown) where they are perceived as sound.

As shown in FIG. 1, the example auditory prosthesis 100 comprises one or more components which are temporarily or permanently implanted in the recipient. The example auditory prosthesis 100 is shown in FIG. 1 with an external component 142 which is directly or indirectly attached to the recipient's body, and an internal component 144 which is temporarily or permanently implanted in the recipient (e.g., positioned in a recess of the temporal bone adjacent auricle 110 of the recipient). The external component 142 typically comprises one or more sound input elements (e.g., an external microphone 124) for detecting sound, a sound processing unit 126 (e.g., disposed in a Behind-The-Ear unit), a power source (not shown), and an external transmitter unit 128. In the illustrative implementations of FIG. 1, the external transmitter unit 128 comprises an external coil 130 (e.g., a wire antenna coil comprising multiple turns of electrically insulated single-strand or multi-strand platinum or gold wire) and, preferably, a magnet (not shown) secured directly or indirectly to the external coil 130. The external coil 130 of the external transmitter unit 128 is part of an inductive radio frequency (RF) communication link with the internal component 144. The sound processing unit 126 processes the output of the microphone 124 that is positioned externally to the recipient's body, in the depicted implementation, by the recipient's auricle 110. The sound processing unit 126 processes the output of the microphone 124 and generates encoded signals, sometimes referred to herein as encoded data signals, which are provided to the external transmitter unit 128 (e.g., via a cable). As will be appreciated, the sound processing unit 126 can utilize digital processing techniques to provide frequency shaping, amplification, compression, and other signal conditioning, including conditioning based on recipient-specific fitting parameters.

The power source of the external component 142 is configured to provide power to the auditory prosthesis 100, where the auditory prosthesis 100 includes a battery (e.g., located in the internal component 144, or disposed in a separate implanted location) that is recharged by the power provided from the external component 142 (e.g., via a transcutaneous energy transfer link). The transcutaneous energy transfer link is used to transfer power and/or data to the internal component 144 of the auditory prosthesis 100. Various types of energy transfer, such as infrared (IR), electromagnetic, capacitive, and inductive transfer, may be used to transfer the power and/or data from the external component 142 to the internal component 144. During operation of the auditory prosthesis 100, the power stored by the rechargeable battery is distributed to the various other implanted components as needed.

The internal component 144 comprises an internal receiver unit 132, a stimulator unit 120, and an elongate electrode assembly 118. In some implementations, the internal receiver unit 132 and the stimulator unit 120 are hermetically sealed within a biocompatible housing. The internal receiver unit 132 comprises an internal coil 136 (e.g., a wire antenna coil comprising multiple turns of electrically insulated single-strand or multi-strand platinum or gold wire), and preferably, a magnet (also not shown) fixed relative to the internal coil 136. The internal receiver unit 132 and the stimulator unit 120 are hermetically sealed within a biocompatible housing, sometimes collectively referred to as a stimulator/receiver unit. The internal coil 136 receives power and/or data signals from the external coil 130 via a transcutaneous energy transfer link (e.g., an inductive RF link). The stimulator unit 120 generates electrical stimulation signals based on the data signals, and the stimulation signals are delivered to the recipient via the elongate electrode assembly 118.

The elongate electrode assembly 118 has a proximal end connected to the stimulator unit 120, and a distal end implanted in the cochlea 140. The electrode assembly 118 extends from the stimulator unit 120 to the cochlea 140 through the mastoid bone 119. In some implementations, the electrode assembly 118 may be implanted at least in the basal region 116, and sometimes further. For example, the electrode assembly 118 may extend towards apical end of cochlea 140, referred to as cochlea apex 134. In certain circumstances, the electrode assembly 118 may be inserted into the cochlea 140 via a cochleostomy 122. In other circumstances, a cochleostomy may be formed through the round window 121, the oval window 112, the promontory 123, or through an apical turn 147 of the cochlea 140.

The elongate electrode assembly 118 comprises a longitudinally aligned and distally extending array 146 of electrodes or contacts 148, sometimes referred to as electrode or contact array 146 herein, disposed along a length thereof. Although the electrode array 146 can be disposed on the electrode assembly 118, in most practical applications, the electrode array 146 is integrated into the electrode assembly 118 (e.g., the electrode array 146 is disposed in the electrode assembly 118). As noted, the stimulator unit 120 generates stimulation signals which are applied by the electrodes 148 to the cochlea 140, thereby stimulating the auditory nerve 114.

While FIG. 1 schematically illustrates an auditory prosthesis 100 utilizing an external component 142 comprising an external microphone 124, an external sound processing unit 126, and an external power source, in certain other implementations, one or more of the microphone 124, sound processing unit 126, and power source are implantable on or within the recipient (e.g., within the internal component 144). For example, the auditory prosthesis 100 can have each of the microphone 124, sound processing unit 126, and power source implantable on or within the recipient (e.g., encapsulated within a biocompatible assembly located subcutaneously), and can be referred to as a totally implantable cochlear implant (“TICI”). For another example, the auditory prosthesis 100 can have most components of the cochlear implant (e.g., excluding the microphone, which can be an in-the-ear-canal microphone) implantable on or within the recipient, and can be referred to as a mostly implantable cochlear implant (“MICI”).

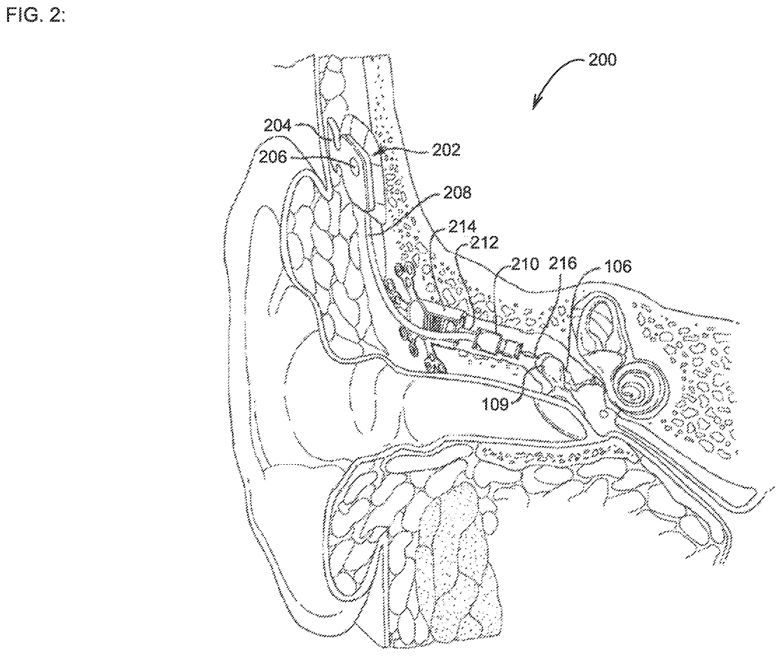

FIG. 2 schematically illustrates a perspective view of an example fully implantable auditory prosthesis 200 (e.g., fully implantable middle ear implant or totally implantable acoustic system), implanted in a recipient, utilizing an acoustic actuator in accordance with certain implementations described herein. The example auditory prosthesis 200 of FIG. 2 comprises a biocompatible implantable assembly 202 (e.g., comprising an implantable capsule) located subcutaneously (e.g., beneath the recipient's skin and on a recipient's skull). While FIG. 2 schematically illustrates an example implantable assembly 202 comprising a microphone, in other example auditory prostheses 200, a pendant microphone can be used (e.g., connected to the implantable assembly 202 by a cable). The implantable assembly 202 includes a signal receiver 204 (e.g., comprising a coil element) and an acoustic transducer 206 (e.g., a microphone comprising a diaphragm and an electret or piezoelectric transducer) that is positioned to receive acoustic signals through the recipient's overlying tissue. The implantable assembly 202 may further be utilized to house a number of components of the fully implantable auditory prosthesis 200. For example, the implantable assembly 202 can include an energy storage device and a signal processor (e.g., a sound processing unit). Various additional processing logic and/or circuitry components can also be included in the implantable assembly 202 as a matter of design choice.

For the example auditory prosthesis 200 shown in FIG. 2, the signal processor of the implantable assembly 202 is in operative communication (e.g., electrically interconnected via a wire 208) with an actuator 210 (e.g., comprising a transducer configured to generate mechanical vibrations in response to electrical signals from the signal processor). Examples of actuators 210 compatible with certain implementations described herein include, but are not limited to: piezoelectric stack, piezoelectric disk; microelectromechanical system (MEMS)-based activator. In certain implementations, the example auditory prosthesis 100, 200 shown in FIGS. 1 and 2 can comprise an implantable microphone assembly, such as the microphone assembly 206 shown in FIG. 2. For such an example auditory prosthesis 100, the signal processor of the implantable assembly 202 can be in operative communication (e.g., electrically interconnected via a wire) with the microphone assembly 206 and the stimulator unit of the main implantable component 120. In certain implementations, at least one of the microphone assembly 206 and the signal processor (e.g., a sound processing unit) is implanted on or within the recipient.

The actuator 210 of the example auditory prosthesis 200 shown in FIG. 2 is supportably connected to a positioning system 212, which in turn, is connected to a bone anchor 214 mounted within the recipient's mastoid process (e.g., via a hole drilled through the skull). The actuator 210 includes a connection apparatus 216 for connecting the actuator 210 to the ossicles 106 of the recipient. In a connected state, the connection apparatus 216 provides a communication path for acoustic stimulation of the ossicles 106 (e.g., through transmission of vibrations from the actuator 210 to the incus 109).

During normal operation, ambient acoustic signals (e.g., ambient sound) impinge on the recipient's tissue and are received transcutaneously at the microphone assembly 206. Upon receipt of the transcutaneous signals, a signal processor within the implantable assembly 202 processes the signals to provide a processed audio drive signal via wire 208 to the actuator 210. As will be appreciated, the signal processor may utilize digital processing techniques to provide frequency shaping, amplification, compression, and other signal conditioning, including conditioning based on recipient-specific fitting parameters. The audio drive signal causes the actuator 210 to transmit vibrations at acoustic frequencies to the connection apparatus 216 to affect the desired sound sensation via mechanical stimulation of the incus 109 of the recipient.

The subcutaneously implantable microphone assembly 202 is configured to respond to auditory signals (e.g., sound; pressure variations in an audible frequency range) by generating output signals (e.g., electrical signals; optical signals; electromagnetic signals) indicative of the auditory signals received by the microphone assembly 202, and these output signals are used by the auditory prosthesis 100, 200 to generate stimulation signals which are provided to the recipient's auditory system. To compensate for the decreased acoustic signal strength reaching the microphone assembly 202 by virtue of being implanted, the diaphragm of an implantable microphone assembly 202 can be configured to provide higher sensitivity than are external non-implantable microphone assemblies. For example, the diaphragm of an implantable microphone assembly 202 can be configured to be more robust and/or larger than diaphragms for external non-implantable microphone assemblies.

The example auditory prostheses 100 shown in FIG. 1 utilizes an external microphone 124 and the auditory prosthesis 200 shown in FIG. 2 utilizes an implantable microphone assembly 206 comprising a subcutaneously implantable acoustic transducer. In certain implementations described herein, the auditory prosthesis 100 utilizes one or more implanted microphone assemblies on or within the recipient. In certain implementations described herein, the auditory prosthesis 200 utilizes one or more microphone assemblies that are positioned external to the recipient and/or that are implanted on or within the recipient, and utilizes one or more acoustic transducers (e.g., actuator 210) that are implanted on or within the recipient. In certain implementations, an external microphone assembly can be used to supplement an implantable microphone assembly of the auditory prosthesis 100, 200. Thus, the teachings detailed herein and/or variations thereof can be utilized with any type of external or implantable microphone arrangement, and the acoustic transducers shown in FIGS. 1 and 2 are merely illustrative.

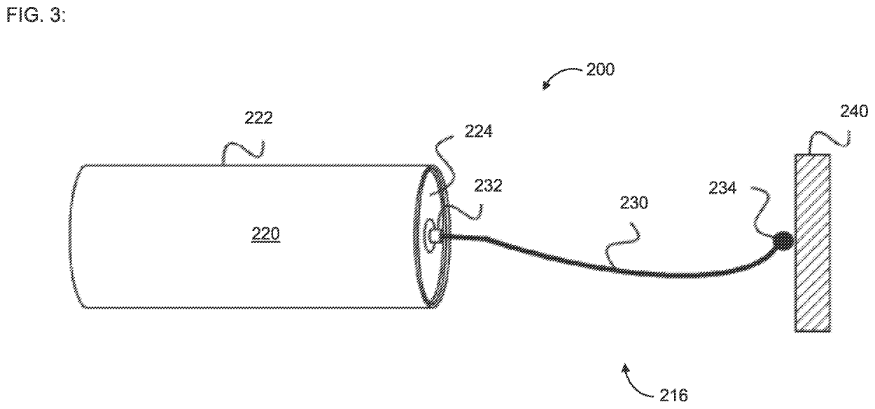

FIG. 3 schematically illustrates a perspective view of an example actuator 210 of another example implantable auditory prosthesis 200 (e.g., fully implantable middle ear implant or totally implantable acoustic system) in accordance with certain implementations described herein. Examples of such implantable auditory prostheses compatible with certain implementations described herein are disclosed by U.S. Pat. Appl. Publ. No. 2013/0116497, which is incorporated in its entirety by reference herein.

The example actuator 210 of FIG. 3 comprises a microphone 220 and a connection apparatus 216, the microphone 220 comprising a biocompatible housing 222 and a diaphragm 224 (e.g., disk-shaped; comprising Ti, a Ti alloy, and/or another biocompatible material). The connection apparatus 216 can comprise an elongate member 230 (e.g., rigid; flexible; straight; curved) having a first end portion 232 mechanically coupled to the diaphragm 224 and a second end portion 234 mechanically coupled to a vibrating structure 240 (e.g., ossicle 106; incus 109; tympanic membrane 104; oval window 112; round window 121; bone surrounding a cochlea; promontory 123; horizontal, posterior, or superior semicircular canals) of the recipient's middle or inner ear. The connection apparatus 216 is sufficiently stiff such that vibrations of the vibrating structure 240 are transmitted by the connection apparatus 216 to the diaphragm 224. The diaphragm 224 can be flexible and configured to vibrate in response to vibrations received from the vibrating structure 240 of the recipient's body via the elongate member 230. The microphone 220 can further comprise a vibration sensor (e.g., electret microphone; electromechanical microphone, piezoelectric microphone: MEMS microphone; accelerometer; optical interferometer; pressure sensor) configured to generate electrical signals in response to and indicative of vibrations of the diaphragm 224. The electrical signals can be provided to a sound processing unit and/or stimulation device (not shown) configured to respond to the electrical signals by generating stimulation signals provided to the recipient to create a hearing percept.

The mechanical coupling between the second end 234 of the elongate member 230 and the vibrating structure 240 can be accomplished in various ways. In certain implementations, the second end 234 is a surface-to-surface mechanical contact (e.g., with a small loading force sufficient to hold the second end 234 in place against the vibrating structure 240 but less than a force that would substantially inhibit or restrict vibration of the vibrating structure 240). In certain other implementations, the second end 234 is secured (e.g., attached; bonded) to the vibrating structure 240. For example, the second end 234 can be affixed directly to the vibrating structure 240 with bone cement or another type of biocompatible adhesive. For another example, the second end 234 can comprise a clip configured to be slid onto the vibrating structure 240. For still another example, the second end 234 can comprise an insert portion and a recess portion (e.g., ball and socket; rod and tube). The recess portion can be secured directly (e.g., clipped; attached; bonded) to the vibrating structure 240 and configured to receive the insert portion such that the insert and recess portions are in mechanical communication with one another. For example, the insert portion can be configured to move relative to the recess portion while remaining mechanically connected to the recess portion. The insert portion can be mechanically coupled to the rest of the elongate member 230 such that three-dimensional vibrations of the vibrating structure 240 are transferred via the elongate member 230 (including the recess portion and the insert portion) to the diaphragm 224.

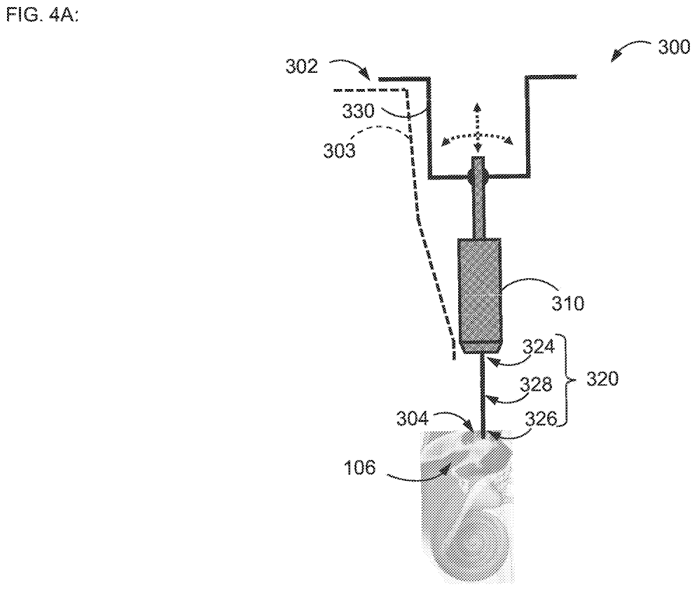

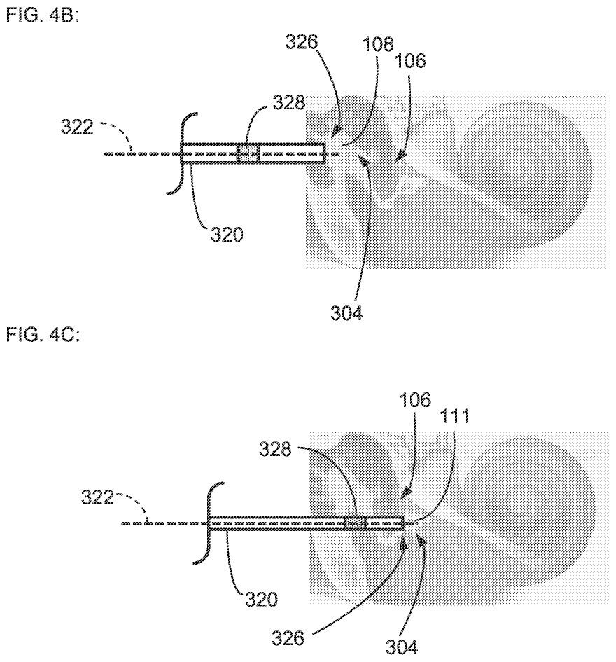

FIGS. 4A-4C schematically illustrate an example apparatus 300 (e.g., an implantable auditory prosthesis 200) in accordance with certain implementations described herein. Examples of such implantable auditory prostheses 200 compatible with certain implementations described herein are disclosed by Int'l Publ. No. WO 2021/260454, which is incorporated in its entirety by reference herein.

In certain implementations, the apparatus 300 comprises a transducer 310 configured to be at least partially implanted on or within a recipient. The apparatus 300 further comprises a conduit 320 having a longitudinal axis 322 and configured to be at least partially implanted on or within the recipient. The conduit 320 comprises a first portion 324 configured to be in mechanical communication with the transducer 310 and a second portion 326 configured to be in mechanical communication with a target portion 304 of the recipient's body. The conduit 320 is configured to transmit vibrations along the longitudinal axis 322 between the transducer 310 and the target portion 304 of the recipient's body. The apparatus 300 further comprises at least one third portion 328 configured to break and/or undergo plastic deformation upon a relative displacement between the transducer 310 and the target portion 304 of the recipient's body exceeding a predetermined threshold value. FIGS. 4B and 4C schematically illustrate the second portion 326 in mechanical communication with two different example target portions 304 (e.g., malleus 108; stapes 111) in accordance with certain implementations described herein.

The apparatus 300 of FIGS. 4A-4C comprises an acoustic prosthesis system comprising a middle ear assembly that is based on two-point fixation with one fixation point at a fixation portion 302 of the recipient's body (e.g., a surface of the recipient's skull 303), a second fixation point at the target portion 304 of the recipient's body (e.g., a middle ear target; ossicle 106; incus 109; tympanic membrane 104; oval window 112; round window 121; bone surrounding a cochlea; promontory 123; horizontal, posterior, or superior semicircular canals), and the middle ear assembly bridging the physical gap between the two fixation points. In certain other implementations, the middle ear assembly is only connected to the target portion 304 of the recipient's body (e.g., the middle ear assembly is floating; only affixed to the tympanic membrane 104 or the ossicles 106). Other types of implantable medical devices besides acoustic prosthesis systems are also compatible with certain implementations described herein.

In certain implementations, the transducer 310 is in mechanical communication with a fixation portion 302 of the recipient's body. For example, as schematically illustrated by FIG. 4A, the apparatus 300 comprises a fixation element 330 (e.g., bracket) configured to be affixed to the fixation portion 302 (e.g., the recipient's skull 303) and to hold the transducer 310 at the fixation portion 302. The middle ear assembly can include a mechanism (e.g., z-adjustment microdrive and compression unit) configured to mechanically couple the transducer 310 to the fixation element 330 and to controllably adjust a linear position (e.g., depth) of the transducer 310 (e.g., about 4 to 10 millimeters) and/or an angle of the transducer 310 relative to the fixation element 330.

In certain implementations, the transducer 310 comprises an actuator configured to generate mechanical vibrations in response to electrical signals indicative of sound received by the auditory prosthesis system and the conduit 320 is configured to conduct the mechanical vibrations generated by the actuator to the middle ear target portion 304 (see, e.g., FIG. 2). In certain other implementations, the transducer 310 comprises a microphone (e.g., comprising a diaphragm) configured to generate electrical signals in response to mechanical vibrations received from the middle ear target portion 304 and the conduit 320 is configured to conduct the mechanical vibrations from the middle ear target portion 304 to the microphone (e.g., the first portion 324 of the conduit 320 is affixed to a diaphragm 224 of the microphone 220; see, e.g., FIG. 3).

In certain implementations, the conduit 320 (e.g., connection apparatus 216) comprises an elongate member 230 (e.g., a rod; wire; cable; tube) comprising at least one metal and/or alloy (e.g., Ti, Pt, Au, stainless steel, nitinol), silicone, polymer (e.g., PMMA), plastic, ceramic, glass, and/or biocompatible adhesive (e.g., bone cement). In certain implementations, the conduit 320 is substantially straight with a substantially straight longitudinal axis 322 (see, e.g., FIGS. 4A-4C), while in certain other implementations, the conduit 320 comprises one or more bends or curves in one or more planes with a bent or curved longitudinal axis 322 (see, e.g., FIG. 3). In certain implementations, the conduit 320 has a substantially circular cross-sectional shape in a plane perpendicular to the longitudinal axis 322 (e.g., the conduit 320 is substantially circularly symmetric about the longitudinal axis 322), while in certain other implementations, the conduit 320 has other cross-sectional shapes (e.g., oval; square; rectangular; irregular) in a plane perpendicular to the longitudinal axis 322.

In certain implementations, the at least one third portion 328 is configured to provide failsafe protection of the target portion 304 from excessively large forces, impulses, and/or torques applied by the conduit 320. For example, such excessively large forces, impulses, and/or torques can be applied to the target portion 304 via the conduit 320 by overstimulation by an actuator 210 or transducer failure and via various other processes, examples of which include but are not limited to: implantation of the auditory prosthesis 200; explantation of the auditory prosthesis 200 (e.g., in which the transducer 310 can be pulled during removal); a recipient undergoing a magnetic resonance imaging procedure; recipient in a fall, vehicle crash, or other high impact event.

Various tissue portions of a recipient's ear are particularly sensitive and/or fragile (e.g., cause pain and/or are damaged by applied forces, impulses, and/or torques with relatively low values), for example:
The ossicles 106 (e.g., incus 109; joints between the ossicles 106) can be damaged by applied torques greater than 1.5 mN-m (e.g., greater than 4 mN-m), which can be caused by magnetic fields applied to the conduit 320 during magnetic resonance imaging (MRI) procedures;
Various forces applied to the short process of the incus 109 can cause damage (e.g., microfractures caused by forces of 450 mN to 700 mN in the antero-posterior direction and/or 250 mN to 500 mN in the lateral-medial direction; severe injury caused by forces of 700 mN to 1000 mN in the antero-posterior direction and/or 550 mN to 800 mN in the lateral-medial direction);
The tympanic membrane 104 can be ruptured by applied forces (e.g., greater than 12 N) or applied pressures (e.g., greater than 40 kPa);
The round window 121 or oval window 112 can be ruptured by applied forces (e.g., greater than 0.5 N) or applied pressures (e.g., greater than 200 kPa).

By breaking in response to applied forces, impulses, and/or torques that have values that are greater than predetermined threshold values but below values that can cause pain and/or damage, the at least one third portion 328 can substantially decouple the target portion 304 from the source of such applied forces, impulses, and/or torques (e.g., by breaking before the applied forces, impulses, and/or torques cause pain to the recipient and/or damage to the tissue). By plastically deforming in response to applied forces, impulses, and/or torques that have values that are greater than predetermined threshold values but below values that can cause pain and/or damage, the at least one third portion 328 can substantially reduce (e.g., dampen) such applied forces, impulses, and/or torques (e.g., by deforming before the applied forces, impulses, and/or torques cause pain to the recipient and/or damage to the tissue). Thus, the at least one third portion 328 can protect the target portion 304 of the recipient's body from forces, impulses, and/or torques being applied to the target portion 304 by the conduit 320 that would otherwise cause pain and/or injury to the target portion 304. In certain implementations, the at least one third portion 328 can be configured to protect the transducer 310 from a loss of hermeticity.

In certain implementations, the predetermined threshold values for breaking and/or plastically deforming the at least one third portion 328 correspond to relative displacements between the transducer 310 and the target portion 304. For example, the at least one third portion 328 can be configured to break and/or plastically deform for relative displacements between the transducer 310 and the target portion 304 greater than 300 microns (e.g., greater than 400 microns) substantially parallel to the longitudinal axis 322 and/or greater than 300 microns (e.g., greater than 400 microns) substantially perpendicular to the longitudinal axis 322. In certain implementations, the at least one third portion 328 has a first predetermined threshold value for plastic deformation and a second predetermined threshold value for breakage, the first predetermined threshold value smaller than the second predetermined threshold value. In this way, the at least one third portion 328 can first undergoes plastic deformation in response to smaller relative displacements but can break in response to sufficiently larger relative displacements.

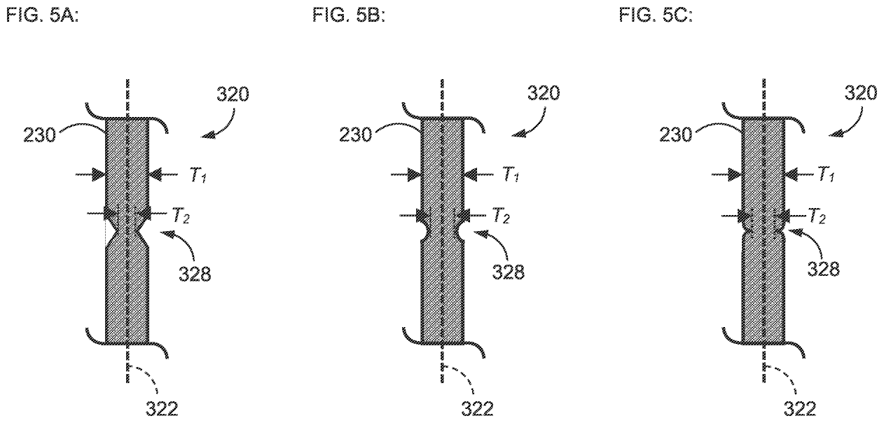

FIGS. 5A-5C, 6A-6D, and 7A-7B schematically illustrate cross-sectional views of portions of example conduits 320 and third portions 328 in accordance with certain implementations described herein. Each of the example conduits 320 of FIGS. 5A-5C, 6A-6D, and 7A-7B comprises an elongate member 230 (e.g., rod, wire, cable, or tube) and the at least one third portion 328 is configured to provide a relatively weak portion of the conduit 320 that is configured to break and/or plastically deform to protect the target portion 304 and/or other portions of the apparatus 300 (e.g., the transducer 310).

FIGS. 5A-5C schematically illustrate cross-sectional views of an elongate member 230 comprising the at least one third portion 328 in accordance with certain implementations described herein. The at least one third portion 328 of FIGS. 5A-5C is between the first portion 324 and the second portion 326 of the conduit 320. In certain implementations, the elongate member 230 has a cross-sectional size and/or shape that is substantially constant along the length of the elongate member 230 (except for at the at least one third portion 328, as described herein), while in certain other implementations, the cross-sectional size and/or shape of the elongate member 230 varies as a function of location along the length of the elongate member 230.

As shown in FIGS. 5A-5C, the elongate member 230 of certain implementations has a first thickness T₁ in a direction substantially perpendicular to the longitudinal axis 322, and the at least one third portion 328 has a second thickness T₂ in the direction substantially perpendicular to the longitudinal axis 322, the second thickness T₂ smaller than the first thickness T₁. For example, the first thickness T₁ can be in a range of 0.05 millimeter to 0.3 millimeter and the second thickness T₂ can be in a range of 25 microns to 100 microns, (e.g., 50 microns). In certain implementations, the ratio (T₂/T₁) of the second thickness to the first thickness can be in a range of 0.5 to 0.95, in a range of 0.6 to 0.9, or in a range of 0.75 to 0.85. The at least one third portion 328 can be positioned closer to the first portion 324 than to the second portion 326, closer to the second portion 326 than to the first portion 324, or substantially equidistant from both the first portion 324 and the second portion 326.

For example, the at least one third portion 328 can comprise a recess (e.g., indentation; channel; groove) having a substantially triangular cross-sectional shape (see, e.g., FIG. 5A) formed by milling a portion of the conduit 320, a substantially circular or ellipsoidal cross-sectional shape (see, e.g., FIG. 5B) formed by stretching (e.g., pulling) a portion of the conduit 320 along the longitudinal axis 322, or a substantially pointed cross-sectional shape (see, e.g., FIG. 5C) formed by compressing a portion of the conduit 320 in a direction substantially perpendicular to the longitudinal axis 322. Other shapes and other methods of formation of the at least one third portion 328 are also compatible with certain implementations described herein. The various shapes and methods of formation can result in different amounts of residual stress in the at least one third portion 328, resulting in different performance in response to relative displacements between the transducer 310 and the target portion 304 of the recipient's body. For example, a third portion 328 with sharper edges (e.g., FIGS. 5A, 5C) can have a sharper step-function-like response to displacements (e.g., a smaller plastic deformation regime before breaking) than a third portion 328 with rounder edges (e.g., FIG. 5B) (e.g., a larger plastic deformation regime before breaking).

In certain implementations, the conduit 320 comprises a single third portion 328 (e.g., as shown in FIGS. 5A-5C), while in certain other implementations, the conduit 320 comprises a plurality of third portions 328. The various third portions 328 can be positioned at different positions along the conduit 320 and can have different predetermined threshold values at which the corresponding third portion 328 is configured to break.

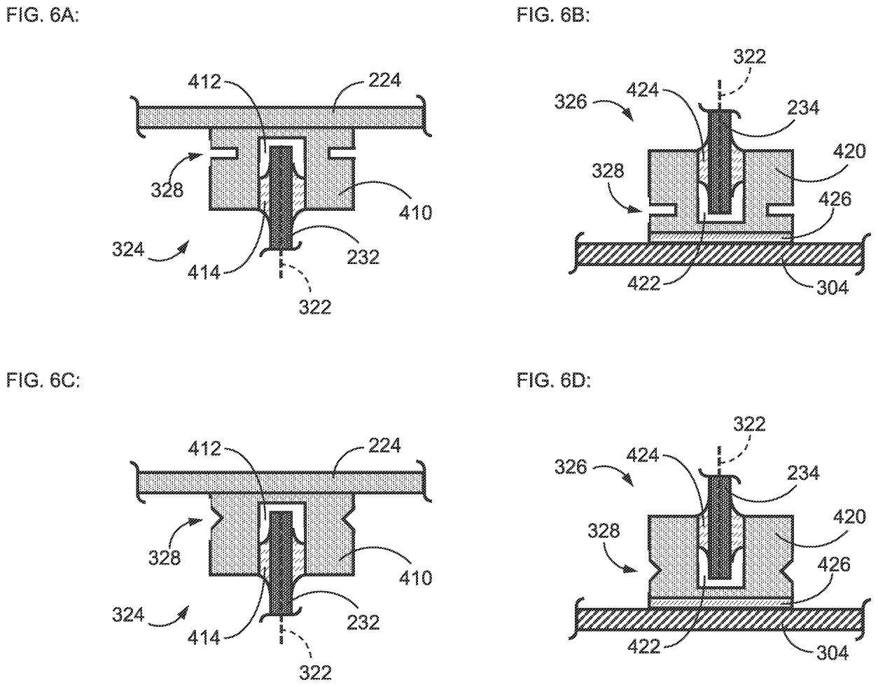

FIGS. 6A-6D schematically illustrate cross-sectional views of an example first portion 324 comprising a first coupler 410 and a second portion 326 comprising a second coupler 420 in accordance with certain implementations described herein. In certain implementations, the first portion 324 of the conduit 320 comprises a first end portion 232 of the elongate member 230 (e.g., solid rod) and a first coupler 410 (e.g., hollow tube) affixed to the first end portion 232 and to the transducer 310 (e.g., diaphragm 224). For example, as shown in FIGS. 6A and 6C, the first coupler 410 can comprise a recess 412 (e.g., blind hole; 2 millimeters deep) configured to receive and be affixed to the first end portion 232 (e.g., by laser welding or adhesive 414). The first coupler 410 can comprise at least one metal and/or alloy (e.g., Ti, Pt, Au, stainless steel, nitinol), silicone, polymer (e.g., PMMA), plastic, ceramic, glass, and/or other biocompatible material). The first coupler 410 and the diaphragm 224 can be a unitary element or can be separate elements affixed to one another (e.g., by laser welding or adhesive). In certain implementations, the first coupler 410 has a substantially circular cross-sectional shape in a plane perpendicular to the first end portion 232 (e.g., the first coupler 410 is substantially circularly symmetric about the first end portion 232), while in certain other implementations, the first coupler 410 has other cross-sectional shapes (e.g., oval; square; rectangular; irregular) in a plane perpendicular to the first end portion 232.

In certain implementations, the first coupler 410 further comprises the at least one third portion 328. For example, as shown in FIGS. 6A and 6C, the at least one third portion 328 can comprise a recess (e.g., indentation; channel; groove; formed by milling and/or compression) having a substantially rectangular cross-sectional shape (see, e.g., FIG. 6A) or a substantially triangular cross-sectional shape (see, e.g., FIG. 6C). Other shapes of the at least one third portion 328 at the first coupler 410 are also compatible with certain implementations described herein. As shown in FIGS. 6A and 6C, the first coupler 410 can have a thickness in a plane substantially perpendicular to the longitudinal axis 322 at the first end portion 232, the thickness smaller at the at least one third portion 328 than away from the at least one third portion 328.

In certain implementations, the second portion 326 of the conduit 320 comprises a second end portion 234 of the elongate member 230 (e.g., solid rod) and a second coupler 420 (e.g., hollow tube) affixed to the second end portion 234 and to the target portion 304 (e.g., ossicle 106). For example, as shown in FIGS. 6B and 6D, the second coupler 420 can comprise a recess 422 (e.g., blind hole; 2 millimeters deep) configured to receive and be affixed to the second end portion 234 (e.g., by laser welding or adhesive 424). The second coupler 420 can comprise at least one metal and/or alloy (e.g., Ti, Pt, Au, stainless steel, nitinol), silicone, polymer (e.g., PMMA), plastic, ceramic, glass, and/or other biocompatible material). The second coupler 420 and the target portion 304 can be affixed to one another (e.g., by biocompatible adhesive 426). In certain implementations, the second coupler 420 has a substantially circular cross-sectional shape in a plane perpendicular to the second end portion 234 (e.g., the second coupler 420 is substantially circularly symmetric about the second end portion 234), while in certain other implementations, the second coupler 420 has other cross-sectional shapes (e.g., oval; square; rectangular; irregular) in a plane perpendicular to the second end portion 234.

In certain implementations, the second coupler 420 further comprises the at least one third portion 328. For example, as shown in FIGS. 6B and 6D, the at least one third portion 328 can comprise a recess (e.g., indentation; channel; groove; formed by milling and/or compression) having a substantially rectangular cross-sectional shape (see, e.g., FIG. 6B) or a substantially triangular cross-sectional shape (see, e.g., FIG. 6D). Other shapes of the at least one third portion 328 at the second coupler 420 are also compatible with certain implementations described herein. As shown in FIGS. 6B and 6D, the second coupler 420 can have a thickness in a plane substantially perpendicular to the longitudinal axis 322 at the second end portion 234, the thickness smaller at the at least one third portion 328 than away from the at least one third portion 328.

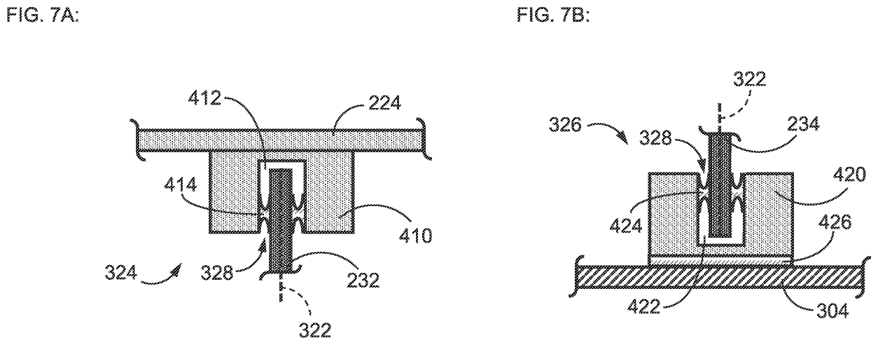

FIGS. 7A and 7B schematically illustrate two cross-sectional views of a first portion 324 and a second portion 326, respectively, of an example conduit 320 in accordance with certain implementations described herein. The at least one third portion 328 of certain implementations is between the first end portion 232 of the elongate member 230 and the first coupler 410 (see, e.g., FIG. 7A) and/or the at least one third portion 328 of certain implementations is between the second end portion 234 and the second coupler 420 (see, e.g., FIG. 7B). For example, the weld and/or adhesive affixing either the first end portion 232 to the first coupler 410 or the second end portion 232 to the second coupler 420 can comprise a narrower or shallower portion or can extend less than completely around the elongate member 230 (e.g., by controlling the volume of adhesive used), thereby providing a bond configured to break upon a relative displacement between the transducer 310 and the target portion 304 exceeding the predetermined threshold value.

For example, the thickness (e.g., diameter) and/or the cross-sectional area of the narrowest portion of the at least one third portion 328 in a plane substantially perpendicular to the longitudinal axis 322 can be selected based, at least in part, on the material of the at least one third portion 328 and the target portion 304 in mechanical communication with the second portion 326. Table I provides some example dimensions in accordance with certain implementations described herein.

TABLE 1

| | Ossicles 106, round window 121, | |
|---|---|---|
| | oval window 112 | Tympanic membrane 104 |
| Metal or alloy | Thickness: 20 μm to 200 μm; | Thickness: 20 μm to 200 μm; |
| (e.g., Ti, Pt, | Area: 300 μm² to 120,000 μm² | Area: 1250 μm² to 120000 μm² |
| Au, stainless | | |
| steel, nitinol) | | |
| Silicone, | Thickness: 15 μm to 400 μm; | Thickness: 50 μm to 400 μm; |
| PMMA | Area: 700 μm² to 500,000 μm² | Area: 7,850 μm² to 500000 μm² |
| Bone cement | Thickness: 10 μm to 200 μm; | Thickness: 20 μm to 200 μm; |
| | Area: 1250 μm² to 120,000 μm² | Area: 1250 μm² to 120,000 μm² |

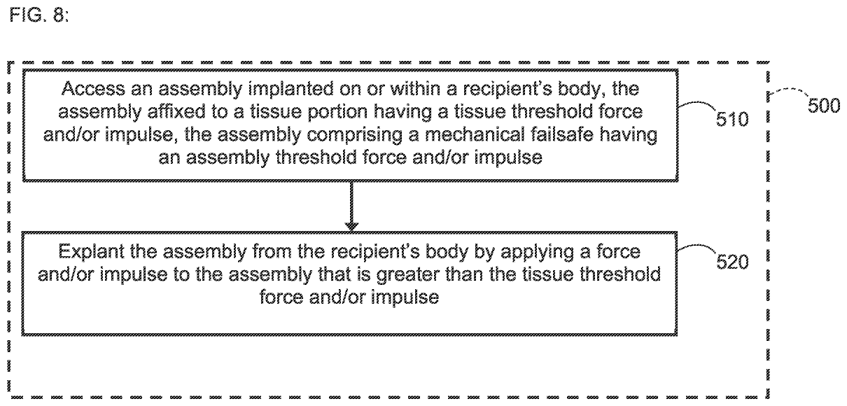

FIG. 8 is a flow diagram of an example method 500 in accordance with certain implementations described herein. While the example method 500 is described herein by referring to the example apparatus 100, 200, 300 of FIGS. 1-3, 4A-4C, 5A-5C, 6A-6D, and 7A-7B, other apparatuses are also compatible with the example method 500 in accordance with certain implementations described herein. For example, the method 500 described herein can be applied to any of a variety of implantable medical devices.

In an operational block 510, the method 500 comprises accessing an assembly (e.g., apparatus 100, 200, 300) implanted on or within a recipient's body. The assembly is affixed to a tissue portion (e.g., target portion 304) having a tissue threshold force and/or impulse such that an applied force and/or impulse greater than the tissue threshold force and/or impulse applied to the tissue portion damages the tissue portion. The assembly comprises a mechanical failsafe (e.g., at least one third portion 328) having an assembly threshold force and/or impulse such that an applied force and/or impulse greater than the assembly threshold force and/or impulse applied to the assembly breaks the mechanical failsafe. The assembly threshold force and/or impulse is less than the tissue threshold force and/or impulse.

For example, the assembly can comprise a transducer 310 and the implanted assembly can be configured to transmit vibrations from the transducer 310 to the tissue portion (e.g., target portion 304) or to transmit vibrations from the tissue portion (e.g., target portion 304) to the transducer 310. Examples of the tissue portion compatible with certain implementations described herein include, but are not limited to: ossicle 106, incus 109, tympanic membrane 104, oval window 112, round window 121, bone surrounding a cochlea 140, promontory 127, and semicircular canals.

In an operational block 520, the method 500 further comprises explanting (e.g., removing) the assembly from the recipient's body. Said explanting comprises applying a force and/or impulse to the assembly that is greater than the tissue threshold force and/or impulse. In certain implementations, the assembly prior to said explanting is further affixed to a second tissue portion (e.g., fixation portion 302) spaced from the tissue portion (e.g., two-point fixation), while in certain other implementations, the assembly prior to said explanting is floating (e.g., only affixed to the target portion 304). For example, said applying the force and/or impulse to the assembly can comprise applying the force and/or impulse to a portion of the assembly on an opposite side of the mechanical failsafe from the tissue portion. In this way, the mechanical failsafe can protect the tissue portion from having excessive force and/or impulse applied to the tissue portion.

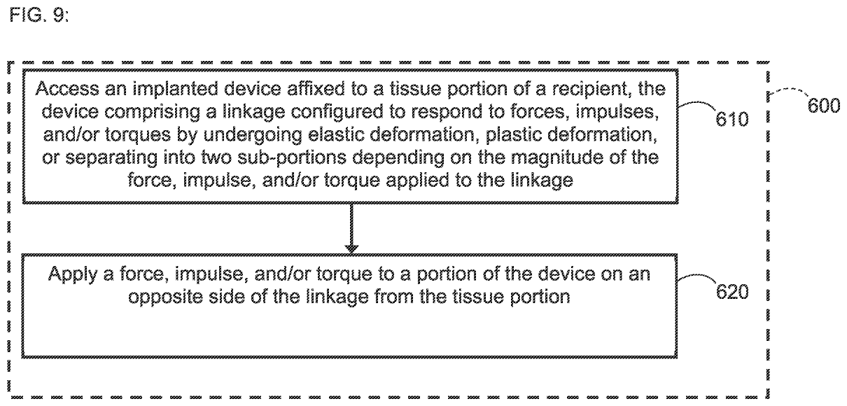

FIG. 9 schematically illustrates another example method 600 in accordance with certain implementations described herein. While the example method 600 is described herein by referring to the example apparatus 100, 200, 300 of FIGS. 1-3, 4A-4C, 5A-5C, 6A-6D, and 7A-7B, other apparatuses are also compatible with the example method 600 in accordance with certain implementations described herein. For example, the method 600 described herein can be applied to any of a variety of implantable medical devices

In an operational block 610, the method 600 comprises accessing an implanted device (e.g., apparatus 100, 200, 300) affixed to a tissue portion of a recipient (e.g., target portion 304). The device comprises a linkage (e.g., at least one third portion 328) configured to respond to forces, impulses, and/or torques having a first range of magnitudes applied to the linkage by undergoing elastic deformation. The device is further configured to respond to forces, impulses, and/or torques having a second range of magnitudes applied to the linkage by undergoing plastic deformation, the second range of magnitudes greater than the first range of magnitudes. The device is further configured to respond to forces, impulses, and/or torques having a third range of magnitudes applied to the linkage by separating into two sub-portions, the third range of magnitudes greater than the second range of magnitudes. In an operational block 620, the method 600 further comprises applying a force, impulse, and/or torque to a portion of the device on an opposite side of the linkage from the tissue portion.

In certain implementations, the tissue portion has a tissue threshold force, impulse, and/or torque magnitude such that a force, impulse, and/or torque having a magnitude greater than the tissue threshold force, impulse, and/or torque magnitude applied to the tissue portion causes pain to the recipient and/or damage to the tissue portion. For example, the force, impulse, and/or torque applied to the device can be greater than the tissue threshold force, impulse, and/or torque magnitude and can be within the second range of magnitudes such that the linkage undergoes plastic deformation and the tissue portion receives a force, impulse, and/or torque magnitude less than the tissue threshold force, impulse, and/or torque magnitude. For another example, the force, impulse, and/or torque applied to the device can be greater than the tissue threshold force, impulse, and/or torque magnitude and can be within the third range of magnitudes such that the linkage breaks and the tissue portion receives a force, impulse, and/or torque magnitude less than the tissue threshold force, impulse, and/or torque magnitude.

Although commonly used terms are used to describe the systems and methods of certain implementations for ease of understanding, these terms are used herein to have their broadest reasonable interpretations. Although various aspects of the disclosure are described with regard to illustrative examples and implementations, the disclosed examples and implementations should not be construed as limiting. Conditional language, such as, among others, “can,” “could,” “might,” or “may,” unless specifically stated otherwise, or otherwise understood within the context as used, is generally intended to convey that certain implementations include, while other implementations do not include, certain features, elements and/or steps. Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

It is to be appreciated that the implementations disclosed herein are not mutually exclusive and may be combined with one another in various arrangements. In addition, although the disclosed methods and apparatuses have largely been described in the context of conventional cochlear implants, various implementations described herein can be incorporated in a variety of other suitable devices, methods, and contexts. More generally, as can be appreciated, certain implementations described herein can be used in a variety of implantable medical device contexts that can benefit from having a mechanical failsafe to protect sensitive and/or fragile tissue.

Language of degree, as used herein, such as the terms “approximately,” “about,” “generally,” and “substantially,” represent a value, amount, or characteristic close to the stated value, amount, or characteristic that still performs a desired function or achieves a desired result. For example, the terms “approximately,” “about,” “generally,” and “substantially” may refer to an amount that is within ±10% of, within ±5% of, within ±2% of, within ±1% of, or within ±0.1% of the stated amount. As another example, the terms “generally parallel” and “substantially parallel” refer to a value, amount, or characteristic that departs from exactly parallel by ±10 degrees, by ±5 degrees, by ±2 degrees, by ±1 degree, or by ±0.1 degree, and the terms “generally perpendicular” and “substantially perpendicular” refer to a value, amount, or characteristic that departs from exactly perpendicular by ±10 degrees, by ±5 degrees, by ±2 degrees, by ±1 degree, or by ±0.1 degree. The ranges disclosed herein also encompass any and all overlap, sub-ranges, and combinations thereof. Language such as “up to,” “at least,” “greater than,” less than,” “between,” and the like includes the number recited. As used herein, the meaning of “a,” “an,” and “said” includes plural reference unless the context clearly dictates otherwise. Also, as used in the description herein, the meaning of “in” includes “into” and “on,” unless the context clearly dictates otherwise.

While the methods and systems are discussed herein in terms of elements labeled by ordinal adjectives (e.g., first, second, etc.), the ordinal adjective are used merely as labels to distinguish one element from another (e.g., one signal from another or one circuit from one another), and the ordinal adjective is not used to denote an order of these elements or of their use.

The invention described and claimed herein is not to be limited in scope by the specific example implementations herein disclosed, since these implementations are intended as illustrations, and not limitations, of several aspects of the invention. Any equivalent implementations are intended to be within the scope of this invention. Indeed, various modifications of the invention in form and detail, in addition to those shown and described herein, will become apparent to those skilled in the art from the foregoing description. Such modifications are also intended to fall within the scope of the claims. The breadth and scope of the invention should not be limited by any of the example implementations disclosed herein, but should be defined only in accordance with the claims and their equivalents.

1. An apparatus comprising:
a transducer configured to be at least partially implanted on or within a recipient; and
a conduit having a longitudinal axis and configured to be at least partially implanted on or within the recipient, the conduit comprising:
a first portion configured to be in mechanical communication with the transducer;
a second portion configured to be in mechanical communication with a target portion of the recipient's body, the conduit configured to transmit vibrations along the longitudinal axis between the transducer and the second portion of the recipient's body; and
at least one third portion configured to break and/or undergo plastic deformation upon a relative displacement between the transducer and the target portion of the recipient's body exceeding a predetermined threshold value.

2. The apparatus of claim 1, wherein the first portion of the conduit is affixed to a disk-shaped diaphragm of the transducer.

3. The apparatus of claim 1, wherein the first portion of the conduit comprises a first end portion of the conduit and the second portion of the conduit comprises a second end portion of the conduit.

4. The apparatus of claim 1, wherein the conduit comprises an elongate member comprising a rod, wire, cable, or tube.

5. The apparatus of claim 4, wherein the elongate member comprises the first portion, the second portion, and the at least one third portion, the elongate member having a first thickness in a direction substantially perpendicular to the longitudinal axis, the at least one third portion having a second thickness in the direction substantially perpendicular to the longitudinal axis, the second thickness smaller than the first thickness.

6. The apparatus of claim 5, wherein the at least one third portion is between the first portion and the second portion.

7. The apparatus of claim 4, wherein the first portion comprises a first end portion of the elongate member and a first coupler affixed to the first end portion and to the transducer, the first coupler comprising the at least one third portion.

8. The apparatus of claim 7, wherein the at least one third portion is between the first end portion and the first coupler and comprises a weld and/or adhesive.

9. The apparatus of claim 7, wherein the at least one third portion comprises a portion of the first coupler, the first coupler having a thickness in a plane substantially perpendicular to the longitudinal axis at the first end portion, the thickness smaller at the at least one third portion than away from the at least one third portion.

10. The apparatus of claim 4, wherein the second portion comprises a second end portion of the elongate member and a second coupler affixed to the second end portion and to the target portion of the recipient's body.

11. The apparatus of claim 10, wherein the at least one third portion is between the second end portion and the second coupler and comprises a weld and/or adhesive.

12. The apparatus of claim 10, wherein the at least one third portion comprises a portion of the second coupler, the second coupler having a thickness in a plane substantially perpendicular to the longitudinal axis at the second end portion, the thickness smaller at the at least one third portion than away from the at least one third portion.

13. The apparatus of claim 1, wherein the transducer is configured to respond to electrical signals by generating mechanical vibrations, the conduit configured to transmit the mechanical vibrations from the transducer to the target portion of the recipient's body.

14. The apparatus of claim 1, wherein the conduit is configured to receive mechanical vibrations from the second portion of the recipient's body and to transmit the mechanical vibrations to the transducer, the transducer configured to respond to the mechanical vibrations from the conduit by generating electrical signals indicative of the mechanical vibrations.

15. The apparatus of claim 1, further comprising a fixation bracket configured to be affixed to the fixation portion of the recipient's body and to hold the transducer at the fixation portion of the recipient's body.

16. The apparatus of claim 1, wherein the transducer is in mechanical communication with a fixation portion of the recipient's body.

17. The apparatus of claim 1, wherein the second portion of the conduit is configured to be in mechanical communication with a portion of the recipient's body selected from the group consisting of: ossicle, incus, tympanic membrane, oval window, round window, bone surrounding a cochlea, promontory, and semi-circular canals.

18. A method comprising:
accessing an assembly implanted on or within a recipient's body, the assembly affixed to a tissue portion having a tissue threshold force and/or impulse such that an applied force and/or impulse greater than the tissue threshold force and/or impulse applied to the tissue portion damages the tissue portion, the assembly comprising a mechanical failsafe having an assembly threshold force and/or impulse such that an applied force and/or impulse greater than the assembly threshold force and/or impulse applied to the assembly breaks the mechanical failsafe, the assembly threshold force and/or impulse less than the tissue threshold force and/or impulse; and
explanting the assembly from the recipient's body, said explanting comprising applying a force and/or impulse to the assembly that is greater than the tissue threshold force and/or impulse.

19. The method of claim 18, wherein the assembly prior to said explanting is further affixed to a second tissue portion spaced from the tissue portion.

20. The method of claim 18, wherein the assembly comprises a transducer and the implanted assembly is configured to transmit vibrations from the transducer to the tissue portion or to transmit vibrations from the tissue portion to the transducer.

21. The method of claim 18, wherein the tissue portion is selected from the group consisting of: ossicle, incus, tympanic membrane, oval window, round window, bone surrounding a cochlea, promontory, and semi-circular canals.

22. The method of claim 18, wherein said applying the force and/or impulse to the assembly comprises applying the force and/or impulse to a portion of the assembly on an opposite side of the mechanical failsafe from the tissue portion.

23. A method comprising:
accessing an implanted device affixed to a tissue portion of a recipient, the device comprising a linkage configured to:
respond to forces, impulses, and/or torques having a first range of magnitudes applied to the linkage by undergoing elastic deformation;
respond to forces, impulses, and/or torques having a second range of magnitudes applied to the linkage by undergoing plastic deformation, the second range of magnitudes greater than the first range of magnitudes; and
respond to forces, impulses, and/or torques having a third range of magnitudes applied to the linkage by separating into two sub-portions, the third range of magnitudes greater than the second range of magnitudes; and
applying a force, impulse, and/or torque to a portion of the device on an opposite side of the linkage from the tissue portion.

24. The method of claim 23, wherein the tissue portion has a tissue threshold force, impulse, and/or torque magnitude such that a force, impulse, and/or torque having a magnitude greater than the tissue threshold force, impulse, and/or torque magnitude applied to the tissue portion causes pain to the recipient and/or damage to the tissue portion.

25. The method of claim 24, wherein the force, impulse, and/or torque applied to the device is greater than the tissue threshold force, impulse, and/or torque magnitude and is within the second range of magnitudes such that the tissue portion receives a force, impulse, and/or torque magnitude less than the tissue threshold force, impulse, and/or torque magnitude.

26. The method of claim 24, wherein the force, impulse, and/or torque applied to the device is greater than the tissue threshold force, impulse, and/or torque magnitude and is within the third range of magnitudes such that the tissue portion receives a force, impulse, and/or torque magnitude less than the tissue threshold force, impulse, and/or torque magnitude.
